(19) United States
(12) Patent Application Publication
(10) Pub. No.: US 2003/0091069 A1
(43) Pub. Date: May 15, 2003

(54) Multiple frequency receiver/player

(76) Inventors: Jessica Kraemer, Monument, CO (US); Maria Pinsky, Colorado Springs, CO (US); Lee Macklin, Colorado Springs, CO (US)

Correspondence Address: HEWLETT-PARKARD COMPANY, Intellectual Property Administration, P.O. Box 272400, Fort Collins, CO, 80527-2400, US

(21) Appl. No.: 09/987,585

(22) Filed: Nov. 15, 2001

(51) Int. Cl. H04J 1/00

(52) U.S. Cl. 370/487

(57) ABSTRACT

A system for presenting separate audio and/or video signals to multiple occupants or groupings of occupants in an automobile is provided. The system includes an input mixer which is utilized to receive signals from a plurality of sources. The signals may include audio, video, graphical, textual, GPS and other signals. The sources may include cassette tape decks, compact disc drives, digital versatile disc players, radio frequency broadcasts, satellite signals and wireless communications signals. The system also includes a multi-channel receiver and amplifier which simultaneously receives and amplifies a plurality of signals. An output mixer also provides specificity as to the output ports upon which a given received and amplified channel is provided to an output device. Output devices include speakers, headphones, and video displays. In an alternative embodiment, a transmitter is provided for transmitting output signals over radio frequencies to wireless headphones and similar devices.

### TECHNICAL FIELD

The technical field relates generally to audio distribution systems. More specifically, the technical field relates to audio distribution systems utilized in automobiles and other moving vehicles, wherein such systems enable multiple persons present in such vehicles to listen to distinct audio programs without interference from other audio programming being presented simultaneously to other persons.

### BACKGROUND

When traveling in automobiles, various occupants often desire to listen to distinct audio programs. For example, an adult occupant (which may be the driver or a passenger) might desire to listen to a certain type of music (for example, classic rock) whereas a teenage passenger might desire to listen to another type of music (for example, rap). Commonly, most automobile audio systems are equipped with certain standard audio components that allow a driver or passenger to select only a single output signal that is presented throughout the vehicle even though multiple input sources may be available. For example, an auto sound system might be configured to receive input signals from compact discs, cassette tapes, radio stations, television stations (when the automobile is video equipped), GPS signals, cellular communications and various other sources of information. FIG. 1 provides a schematic illustration of a simple system 100 in which standard audio sources are provided.

As shown, such a system 100 commonly includes a receiver and amplifier 102 that receives signals from various input sources, amplifies the signal and outputs the selected signal to various speaker systems. Further, the system 100 commonly includes an antenna system 108 (which suitably includes any necessary pre-amplifiers, filters, and the like) that is connected to the receiver 102 through a communications medium 103 at an input port 114 on the receiver 102. As is commonly appreciated, the antenna 108 (and, by correlation, the receiver 102) may be configured to receive communications signals on various frequencies including, but not limited to, AM radio frequencies, FM radio frequencies, broadcast TV frequencies, satellite TV frequencies, cellular frequencies, and other frequencies commonly used to receive and/or transmit communications signals. The receiver 102 suitably selects a communications signal from the antenna for reception and amplification when desired.

The system 100 also commonly includes various input sources such as a cassette tape deck 104 and/or a compact disc player 106. These are suitably connected to the receiver 102, for example, through communications link 105 and 107 and through input ports 116 and 118, respectively. Further, it is common for the compact disc player 106 and/or cassette tape deck 104 to be integrated into a single unit with the receiver 102.

Various speakers 110 and 112 are also commonly connected to the receiver 102. Often four, six, or even eight speakers are provided in an automobile sound system. For purposes of simplicity, two speakers are shown in FIG. 1. Further, it is commonly appreciated that the speakers are often assigned to specific locations in the vehicle, for example, front speakers versus rear speakers. Suitable output ports 120 and 122 are usually provided by the receiver 102 and are used to connect the multitude of speakers to the receiver 102. While volume control knobs are often provided and by which occupants may adjust the sound volume in a given location within the automobile, such systems 100 generally require all the occupants of the automobile to listen to the same audio signals

Therefore, while automobile sound systems in recent years have increased tremendously the number of input sources, output ports and the quality of the sound provided in automobiles, there still exists a need for systems that enable various occupants to listen to one audio signal while other occupants listen to other audio signals. In short, a system is needed that enables occupants to listen to those audio programs they desire in an automobile while other occupants listen to a different audio program at the same time, without requiring the occupants to provide their own sound distribution systems (i.e., without requiring certain occupants to utilize a MP3 player, a SONY® WALKMAN®, a “boom box”, or a similar device).

Further, automobiles often now include video systems, GPS systems, mobile computing systems and other systems that provide audio, video, graphical, textual, and/or other types of information signals. As such, the need is ever greater for a system and process that enables occupants and/or groups of occupants to be presented with specific audio/video signals while other occupants are presented with a different audio/video signal.

### SUMMARY

A system is provided that enables occupants of a vehicle to select specific audio programs for presentation to such occupant without requiring other occupants to listen to the same audio program. The system also enables such other occupants to select other audio programs which they may listen to simultaneously with the presentation of the first audio program. While the present Summary and Detailed Description are directed towards an audio sound system and audio signals, it is to be appreciated that the present invention is not to be construed as being so limited. Audio, video, graphical, textual and other types of signals may be suitably communicated to specific occupants or groups of occupants. As such, throughout this description audio signals are to be interpreted as including, where appropriate, video signals, graphical signals, textual signals and signals in other formats that can be suitably presented to a person.

In one embodiment, a system is provided that utilizes many of the input signals provided by commonly available input devices, for example, radio frequency signals provided through an antenna, signals from a cassette tape deck, and/or signals from a compact disc player. These signals are received by a single receiving device that includes multiple receiver/amplifiers, and multiple output channels. Input mixers are suitably provided and utilized to select an input signal for reception and/or amplification by one of the device's receivers/amplifiers. Similarly, output mixers are suitably provided and utilized to select which received and amplified signal is to be provided to a specific audio presentation device (for example, a speaker or a headphone). The location of the selected audio presentation device and the connection thereto, through the receiver/amplifier, to a given audio signal is suitably controlled by a simple and easy-to-use interface provided by the device.

In another embodiment, a system further includes a transmitter that allows for the separate transmission of audio signals to wireless devices (for example, head-phones). Preferably, a transmitter is provided that is capable of transmitting multiple audio signals over multiple communications channels. Further, in yet another embodiment combinations of wired and wireless connections may be utilized to present distinct audio signals to specific occupants in an automobile and/or to specific regions of an automobile.

These and other features are further described herein with reference to the drawing figures, detailed description and the claims.

### DESCRIPTION OF THE DRAWINGS

FIG. 1 is a schematic representation of a conventional audio sound system commonly utilized in automobiles;

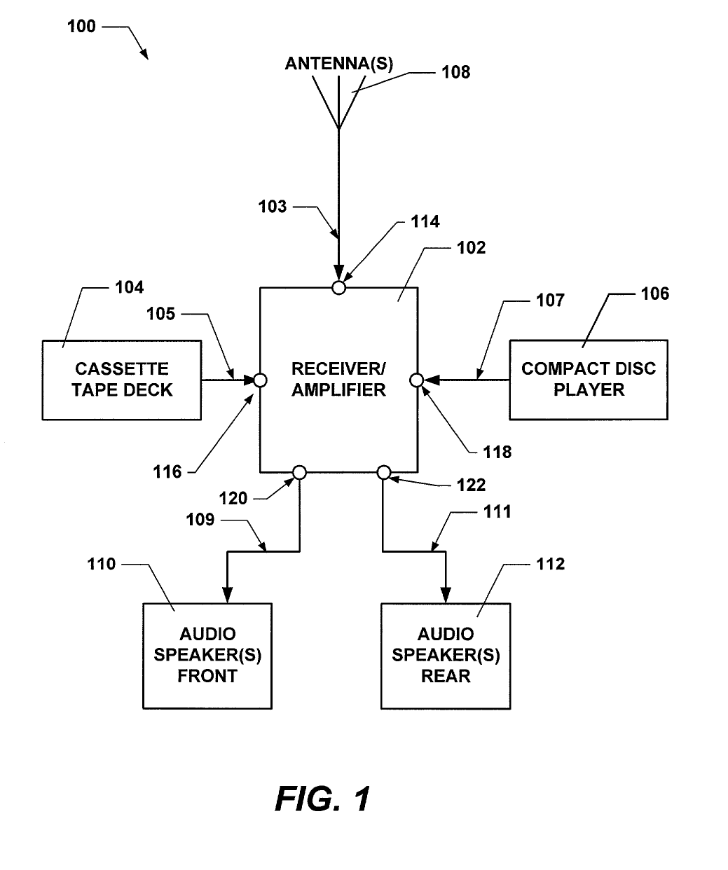

FIG. 2 is a schematic representation of one embodiment where multiple audio signals are simultaneously presented to specific regions of an automobile through a wired speaker system;

FIG. 3 is a schematic representation of another embodiment where multiple audio signals are simultaneously presented to specific occupants of an automobile through a wireless sound distribution system;

FIG. 4 is a schematic representation of another embodiment where multiple audio signals are simultaneously presented to occupants of an automobile through a combined wired and wireless sound distribution system; and

FIG. 5 is a flow chart illustrating one method by which a receiving unit may be configured to provide multiple channels to specific occupants and/or groups of occupants in an automobile.

### DETAILED DESCRIPTION

As discussed previously, a system is provided for presenting a plurality of audio signals to various occupants of a vehicle. More specifically, the system enables occupants of a vehicle to listen to various audio signals without requiring all the occupants to listen to the same signal and without requiring the occupants to utilize additional and/or stand-alone sound reproduction systems (for example, separate WALKMAN® units or the like).

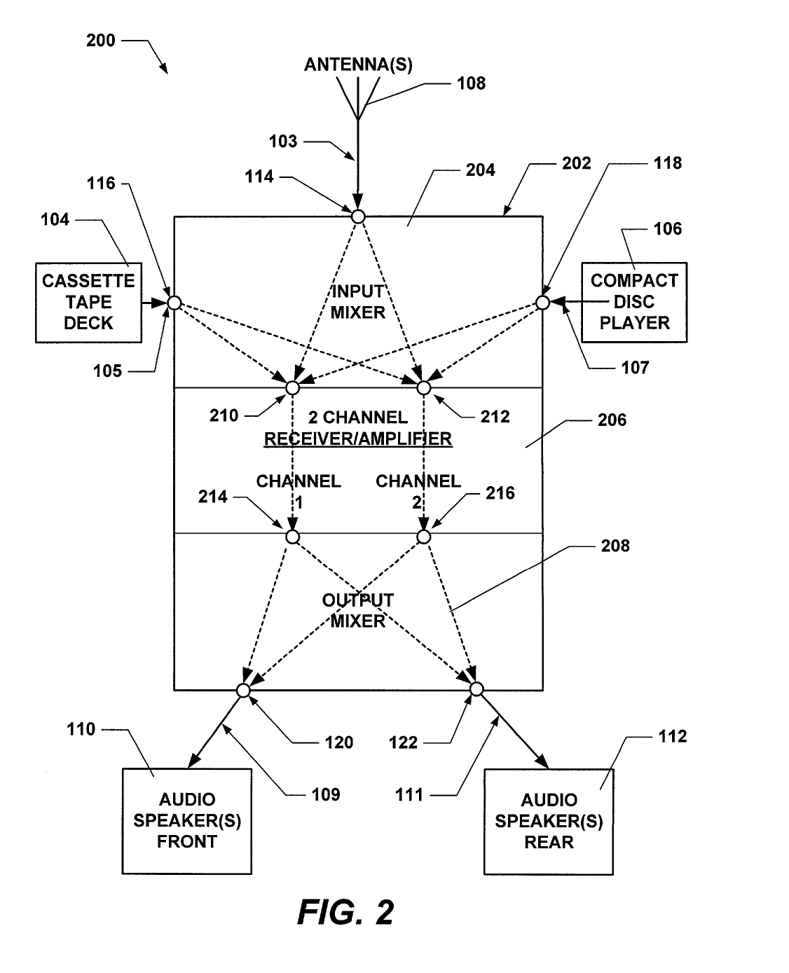

As shown in FIG. 2, one embodiment of a system 200 for presenting multiple audio signals to occupants of an automobile utilizes a multiple channel receiver and amplifier system. The system 200 includes a receiving unit 202 that further includes a multi-channel receiver/amplifier 206. In FIG. 2, the multi-channel receiver/amplifier 206 is illustrated as a two channel unit. It is to be appreciated, however, that any number of channels may be configured into the multi-channel receiver/amplifier 206 as particular needs may determine. For example, in a large automobile, carrying numerous persons (for example, a six passenger mini-van) a channel may be desired for every seat in the vehicle (i.e., a six channel unit may be desired). Contrarily, for a small vehicle (for example, a two passenger sports car) only two channels may be desired. Further, in most applications, it is anticipated that a two channel unit is sufficient to address the various listening needs of most occupants of an automobile.

Further, the receiving unit 202 also includes an input mixer 204 and an output mixer 208. As is commonly known and appreciated in the art, input and output mixers may be provided in solid-state components, or more commonly as portions of an integrated circuit or a circuit assembly. As such, in some devices the input and output mixers may not be separate or distinguishable units and may be provided as an element of the processing features and functions of a receiving unit 202. Thus, it is to be appreciated that the input and output mixers 204 and 208, respectively, are provided in FIG. 2 primarily for illustrative purposes and the receiving unit 202 is not to be construed as being limited to such an actual configuration and/or embodiment.

As illustrated in FIG. 2, the input mixer 204 is configured to receive a plurality of input signals from a plurality of sources at input terminals 114, 116 and 118. For example, sources may include a cassette tape deck 104 or a compact disc player 106, or a similar device that provides a signal from a portable storage device, for example, a compact disc, a magnetic tape, a video tape, a digital versatile disc, a memory stick or any other data storage medium. Further, the input mixer 204 may be connected to an antenna(s) 108 that is configured to receive electromagnetic signals at various wavelengths. As is commonly known, such signals may include radio signals, cellular or other wireless communications signals, television signals, satellite signals and any other signal capable of being communicated to a receiving unit. Further, such sources 104, 106, and/or 108 are also connected to the input mixer 204 through appropriate or desired communications links 105, 103, and 107, respectively. Such communications links may be wired or wireless.

As shown in FIG. 2, the input mixer 204 effectively establishes connections between a given source and a channel provided by the multi-channel receiver/amplifier 206. For purposes of illustration, nodes 210 and 212 are shown as providing inputs to respective channels in the multi-channel receiver/amplifier 206. It is to be appreciated, however, that the various channels provided by a receiving unit may be received, amplified and output by a single amplifying circuit that utilizes the needed filters, amplifiers, and other devices necessary to so configure a multiple channel output signal. Thus, any available multi-channel receiver/amplifier may be utilized or, alternatively, multiple instances of single channel receivers/amplifiers may be used.

Further, as illustrated in FIG. 2, such receivers/amplifiers effectively include output nodes 214 and 216 that correspond to the given channels. The signals at such output nodes 214 and 216 are appropriately routed by the output mixer 208, or its functional equivalent, at any instant and/or as specified by a user to a desired output device. Examples of such output devices may include, for example, the front audio speakers 110 and the rear audio speakers 112 in an automobile. As illustrated, each such set of speakers may be configured to receive any of the plurality of channels processed by the multi-channel receiver/amplifier 206. For example, the channel 1 signal might be connected to both node 120 and node 122, from which suitable connections 109 and 111 (which may be wired or wireless) are provided to the audio speakers 110 and 112. Alternatively, channel 1 might be configured to be presented on only the rear audio speakers 112, through node 122 only, while channel 2 is configured to be presented on only the front audio speakers 110, through node 120 only. As such, numerous combinations and permutations may be provided by the plurality of input sources, the number of channels on the multi-channel receiver/amplifier 206 and the number of output devices.

Further, the receiving unit 202 is preferably configured so that users may easily specify particular signals to be presented to users through particular output devices. In short, the system 200 may be configured such that the users specify the destination of particular audio channels. In additional embodiments, the system 200 may also be configured such that the receiving unit 202 automatically routes the audio signal to specific output devices based upon the type of signal received, driving regulations (for example, video signals should not be presented to a driver of a moving vehicle) and the intended audience.

For example, when the antenna 108 receives a wireless telephone call intended for the driver, the system may be configured to automatically present the call to the driver through output devices proximate to the driver. Meanwhile, music or other audio signals may be increased in volume in the proximity of other passengers, as desired and/or necessary. Such a configuration may create some semblance of privacy in a call (by prohibiting others from hearing the call), while minimizing the interference of other audio signals during the call. Thus, it is to be appreciated that the receiving unit 202 may be configured to manually and/or automatically distribute audio signals, as desired, to a plurality of output devices.

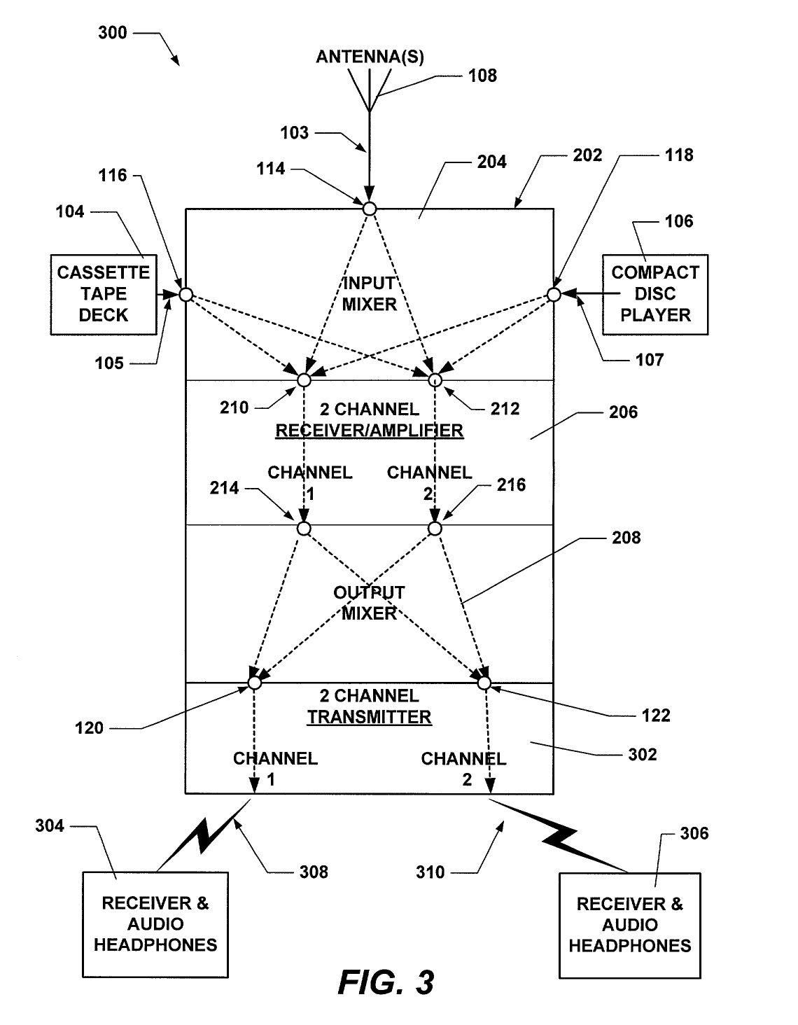

Referring now to FIG. 3, another embodiment of a system 300 is illustrated. In this embodiment, the receiving unit 302 further includes a multi-channel transmitter 302. The multi-channel transmitter 302 is appropriately configured to transmit electromagnetic signals on appropriate communications links 308 and 310 at appropriate frequencies to receiving units, such as a set of combined receiver and audio headphones 304 and 306, respectively. In this embodiment, even greater selectivity and/or exclusivity of audio communications can be provided since various occupants of an automobile may be presented with unique audio signals that only they can hear through the wireless headphone devices.

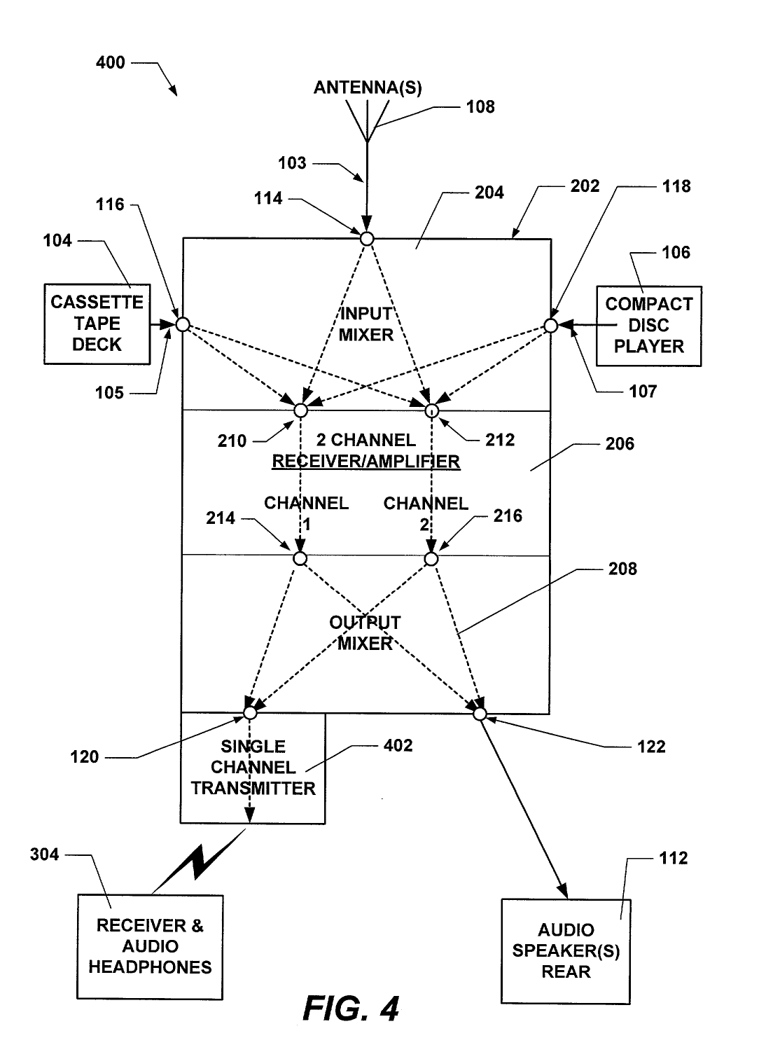

FIG. 4 illustrates another embodiment of a system 400 wherein both general broadcast audio signals can be presented through an audio speaker 112 and private communications can be provided through headphones 304. In FIG. 4, the transmitter 402 is illustrated as a single channel transmitter, however, it is to be appreciated that multiple channel transmitters may be utilized as desired. Similarly, only rear audio speakers 112 are illustrated. As discussed previously herein and provided in the previous embodiments multiple speaker arrangements may be utilized as desired. Thus, FIGS. 2-4 illustrate various embodiments that may be utilized to provide multiple audio and/or video channels in an automobile so that specific occupants, areas of a vehicle, or other groupings may be presented with specific audio and/or video signals. As discussed previously, such groupings may be predetermined, manually specified, and/or automatically specified. Further, the automatic specification may be based upon the intended audience for a given audio/video signal, the content of the audio/video signal, and/or any other parameter. Such parameters may be suitably loaded or programmed into the receiving unit 202 and stored in registers or a suitable data storage device (not shown).

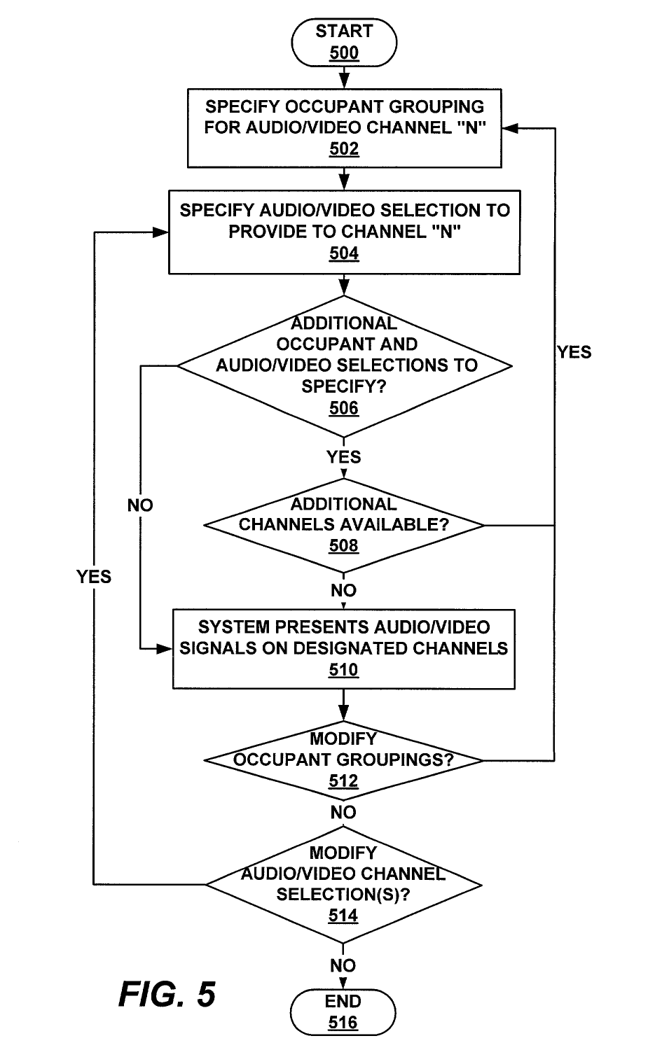

FIG. 5 provides a flow chart illustrating one method which may be utilized to specifically tailor audio/video signals to specific occupants in a vehicle. As shown this process begins (block 500) with specifying occupants or groups of occupants for a given audio channel and their relative position in a vehicle (Block 502). For example, a receiving unit 202 might be configured with preset buttons specifying, for example, front seat and back seat of a vehicle, adults and kids, driver and passengers, or any other designation. Similarly, a receiving unit 202 might be configured with a touch screen display (for example, on which one may identify positions of occupants in a vehicle and their desired audio selections). Similarly, a voice recognition unit, or other device may be utilized and may enable an operator of the receiving unit to specify how the automobile's audio distribution system (i.e., the combination of wired and/or wireless speakers and/or headphones) is to be configured. It is to be appreciated that as the number of channels provided by the receiving unit 202 increases, so does the complexity of specifying audio/video groupings. Therefore, to limit the amount of configurations necessary, the preferred embodiment utilizes a two channel receiving unit.

After specifying how a group of occupants are organized or located in the automobile and associated with a given channel, the process continues with the operator designating which audio signal is to be provided to a given channel (block 504). For example, a given channel may be designated to receive cellular telephone calls and a signal from a radio station, while another channel may be configured to receive the audio and/or video signals for a movie playing on a DVD player. Preferably, the selection of the audio/video signal to provide through a given channel (which is associated with an occupant or grouping of occupants) is accomplished after specifying the occupant grouping. However, a system may also be configured such that the assignment of audio/video signals to a given channel is accomplished first and the occupants that are to receive a given channel are specified at a later time.

Regardless of the order in which the occupant to channel specification or the audio/video selection to channel specification occurs, the process continues with matching occupants to channels and channels to audio/video signal selections until either all the occupant and audio/video selections have been specified (block 506), or all the available channels have been specified (block 508). More specifically, when all the occupants and audio/video selections have been specified (block 506), the process continues with presenting the audio/video signals on the designated channels (510). When additional occupant and audio/video selections remain to be specified (block 506), the process determines whether additional channels are available (block 508). If additional channels are available, the process then loops through blocks 502-508 until either all the occupant and audio/video selections have been specified or nor are no more additional channels available (block 508). At which instance, the process continues with providing the desired audio/video signals on the specified channels to the occupants (block 510).

It is to be appreciated that a given system is often limited as to the number audio/video signals the system can present at any given time by the number of channels provided by the system. However, it is also to be appreciated that a given channel may be assigned (or switched between) more than one input signal source and the receiving unit may be configured to appropriately select a signal available for a given channel based upon the occurrence of a pre-determined event. For example, a channel might be configured to provide an audio signal from a radio station until either a cellular call is received or an outgoing call is initiated. In both instances, the receiving unit desirably switches off the incoming audio radio signal and provides the cellular signal on the channel, thereby facilitating a clearer cellular telephone call. Meanwhile, a second channel (which may or may not, at that time, be configured to present a distinct signal) may be configured to automatically continue presenting the audio radio signal to other areas or occupants of the automobile, and thereby provide some privacy to the occupant receiving the incoming or outgoing call. Such privacy could be especially provided when headphones were being used by certain occupants to receive an audio signal.

Upon presenting the audio/video signal(s) to the occupant(s) on the desired channels, the process continues to provide such signals until the receiving unit: receives a request to modify groupings of occupants with a channel (block 512); receives a request to modify an audio/video signal associated with a given channel (block 514); or is turned off (block 516). As shown in FIG. 5, upon receiving a request to modify groupings of occupants with a channel (block 512, the process continues with the operator again specifying occupant grouping for a channel (block 502). Similarly, upon receiving a request to modify an audio/video signal associated with a given channel (block 514), the process continues with the operator again specifying an audio/video signal selection to provide to channel (block 504).

Further, it is to be appreciated, that the receiving unit may be configured such that a given channel is the active channel. When so configured, an operator may change the input audio/video signal selections for the active channel without effecting the signal selection being provided on another channel. Such a feature may be desirable, for example, when children are watching a movie on channel two and the driver is constantly surfing radio signals on channel 1. Further, in certain other embodiments, remote signal controls may be provided in the vehicle, for example, in the rear seating area of a minivan. Such remote signal controls may be utilized by occupants in the general proximity to control the volume, channel, and/or audio/video input selection provided on a channel.

While the present invention has been described in the context of certain system embodiments and process flows, it is to be appreciated that the present invention is not so limited and should be considered to include modifications, additions and deletions thereto and such shall be considered to be within the scope of the present invention, as set forth by the specification, the drawing figures and the claims.

1. A system for simultaneously receiving, processing, outputting and presenting multiple distinct signals on multiple channels to a plurality of occupants in an automobile, comprising:
a plurality of input ports, for simultaneously receiving a plurality of distinct signals from a plurality of sources;
a plurality of output ports, for simultaneously outputting each of a plurality of processed distinct signals;
a plurality of output devices, connected to the plurality of output ports, for simultaneously presenting at least one of a plurality of processed distinct signal to each of a plurality of occupants in an automobile;
a receiving unit, connected to the plurality of input ports and the plurality of output ports, further comprising:
an input mixer, connected to the plurality of input ports, for establishing a plurality of electrical connections between each of the plurality of sources received via the plurality of input ports and each of a plurality of channels;
a multi-channel receiver and amplifier unit, connected to the input mixer, for receiving and amplifying each signal present on each of the plurality of channels; and
an output mixer, connected to the multi-channel receiver and amplifier unit and the plurality of output ports, for establishing a second plurality of electrical connections between each of the plurality of channels and the plurality of output ports; whereupon establishing the plurality of electrical connections between the plurality of input ports and the receiving unit, and the second plurality of electrical connections between the receiving unit and the plurality of output ports, each of the plurality of occupants in the automobile may be simultaneously presented, via the plurality of output devices, with processed distinct signals.

2. The system of claim 1, wherein at least one of the plurality of sources further comprises a radio frequency broadcast system, a cassette tape deck, a compact disc player, a digital versatile disc player, a video tape player, a cellular communications system, a wireless communications system, and a global positioning system.

3. The system of claim 1, whereupon reception of a distinct signal in a given format on a given port of the plurality of input ports, the receiving unit configures the input mixer to establish an electrical connection between the given port and a channel configured to receive the distinct signal in the given format, and the receiving unit configures the output mixer to establish an electrical connection between the channel and a given output port, wherein the given output port is configured to provide to at least one compatible output device a processed distinct signal in the given format.

4. The system of claim 3, wherein at least one of the distinct signals is received in at least one of an audio format, a video format, a combined audio-video format, a graphical format and a textual format.

5. The system of claim 4, wherein at least one of the plurality of output devices includes an audio speaker and when at least one of the distinct signals is received in an audio format, at least one output port of the plurality of output ports is electrically connected to the audio speaker.

6. The system of claim 4, wherein at least one of the plurality of output devices includes a television monitor and when at least one of the distinct signals is received in a combined audio-video format, the receiving unit outputs at least one of an audio signal, a video signal and a combined audio-video signal to at least one output port of the plurality of output ports configured to establish a connection with the television monitor.

7. The system of claim 6, wherein at least one of the plurality of output devices further includes at least one audio speaker and the receiving unit outputs the audio signal to at least one output port of the plurality of output ports configured to establish a connection with the at least one audio speaker.

8. The system of claim 1, wherein at least one output port of the plurality of output ports is configured to provide a processed distinct signal to at least one of the plurality of output devices via a wireless connection.

9. The system of claim 1, wherein at least one of the plurality of occupants is designated to receive a specific signal based upon a seating position of the occupant in the automobile.

10. The system of claim 1, wherein the receiving unit further comprises a multi-channel transmitter, connected to the output mixer, for transmitting electromagnetic signals to at least one output device configured to receive electromagnetic signals.

11. A system for simultaneously providing a first signal to at least one first occupant of a vehicle while at least one other second occupant of the vehicle receives at least one of a plurality of second signals, comprising:
a means for designating a first signal to provide on a first channel;
a means for designating which of a plurality of second signals to provide on a plurality of second channels;
a means for receiving and amplifying the first signal provided on the first channel;
a means for receiving and amplifying each of the plurality of second signals provided on the plurality of second channels;
a means for designating upon which of a plurality of output ports the first signal and each of the plurality of second signals are to be provided;
whereupon connection of an output device to at least one of the plurality of output ports, the output device is provided at least one of the first signal and the plurality of second signals for presentation to at least one occupant of a vehicle.

12. The system of claim 11, wherein the means for designating a first signal to provide on a first channel and the means for designating which of the plurality of second signals to provide on a plurality of second channels further comprise an input mixer, wherein the input mixer further comprises:
a plurality of input nodes, for establishing a connection with a source of each of the first signal and the plurality of second signals;
a plurality of output nodes associated with each of the first channel and the plurality of second channels, for connecting the output of the input mixer to the input of the means for receiving and amplifying the first signal and the means for receiving and amplifying the plurality of second signals; and
a configurable connecting means for establishing a connection between at least one of the plurality of input nodes and at least one of the plurality of output nodes.

13. The system of claim 12, wherein at least one of the first signal and the plurality of second signals comprises at least one of an audio signal, a video signal, a combined audio-video signal, a graphical signal, and a textual signal.

14. The system of claim 13, wherein the output device further comprises at least one of an audio speaker, a headphone, and a video monitor.

15. A method for providing a first signal on a first channel provided by a multi-channel receiver and amplifier to a first occupant of an automobile while a plurality of second occupants of the automobile receive at least one of a plurality of second signals on at least one second channel, comprising:
associating a first occupant of an automobile with a first channel;
specifying a signal to provide on the first channel;
associating at least one of a plurality of second occupants of the automobile with at least one second channel;
specifying a second signal from a plurality of second signals to provide on the at least one second channel;
presenting the first signal to the first occupant through the first channel;
presenting the second signal to the at least one of the plurality of second occupants associated with the second channel;
determining whether a modification is desired to either a specification of an occupant with a channel or a signal with a channel; and
if a modification is desired, re-accomplishing the above steps such that a specification of an occupant with a channel or a signal with a channel is set as desired.

16. The method of claim 15, wherein prior to presenting the first signal to the first occupant through the first channel, the method further comprises:
determining whether any additional occupant or additional signal exists that needs to be specified to an additional channel;
if any additional occupant or additional signal exists, the process further comprises:
determining whether any additional channels are available; and
if additional channels are available, repeating the above steps; and
presenting any additional signal to any additional occupant through any additional channel.

17. The method of claim 16, wherein at least one of the first occupant, the plurality of second occupants, and the additional occupant further comprises a grouping of at least three occupants in the automobile.

18. The method of claim 16, wherein at least one of the first signal, the second signal and the additional signal comprises at least one of an audio signal and a video signal.

19. The method of claim 15, wherein at least one of the first occupant, the plurality of second occupants, and the additional occupant are identified by a location within the automobile.

20. The method of claim 19, wherein the location is identified as either a front seat or a rear seat in the automobile.
